(19) United States
(12) Patent Application Publication
(10) Pub. No.: US 2010/0263846 A1
(43) Pub. Date: Oct. 21, 2010

(54) Plate Heat Exchanger Having Profiles

(75) Inventors: Rainer Dietz, Gruenwald (DE); Bruno Nowakowski, Engelsberg (DE); Herbert Aigner, Engelsberg (DE); Rudolf Wanke, Ottenhofen (DE); Florian Winnen, Miesbach (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: LINDE Aktiengesellschaft, Muenchen (DE)

(21) Appl. No.: 12/763,587

(22) Filed: Apr. 20, 2010

(30) Foreign Application Priority Data
Apr. 21, 2009 (DE) 102009018247.0

(51) Int. Cl. F28F 3/14; B23P 15/26

(52) U.S. Cl. 165/170; 29/890.039

(57) ABSTRACT

The invention describes a plate heat exchanger and a method for producing a plate heat exchanger. The plate heat exchanger consists of a multiplicity of passages 1a, 1b which are arranged in stack form and which are separated from one another by separating sheets 2. The passages 1a and 1b in this case consist of a multiplicity of hollow profiles 5 arranged next to one another.

### SUMMARY OF THE INVENTION

The invention relates to a plate heat exchanger for heat exchange between at least two media, consisting of a multiplicity of passages which are arranged in stack form and which are separated from one another by separating sheets, the passages being structured, and to a method for producing a plate heat exchanger. The invention is described with reference to a plate heat exchanger made from aluminium, but can be used, in principle, for any heat exchanger which provides heat exchange between at least two media, and comprises a multiplicity of structured passages arranged in stack form and separated from one another by separating sheets. In particular, the present invention is suitable for use in plate heat exchangers, made from high-grade steel or high-temperature steel, based on what is known as the bar/plate principle.

Conventionally, plate heat exchangers made from aluminium, for heat exchange between at least two media, have a multiplicity of passages which are arranged in stack form and which are separated from one another by separating sheets. The individual passages are basically similar and are arranged in parallel. Heat exchange between the participating media in this case takes place between adjacent passages. The passages and therefore the media or pressure spaces are separated from one another by sheets, usually designated as separating sheets. Heat exchange takes place by means of heat transfer via the separating sheets. Pressure space generally refers to a closed area of space where the same pressure applies.

According to the prior art, a wavy structure which forms the ducts or flow channels for routing the medium are present within the individual passages. The wave crests of the wavy structure are connected to the respectively adjacent separating sheets. The media participating in heat exchange are thus in direct thermal contact with the wavy structures, so that heat transition is ensured as a result of thermal contact between the wave crests and separating sheets. To optimize the heat transfer, the orientation of the wavy structure is selected as a function of the application, such that co-current, cross-current, countercurrent or cross-/countercurrent flow becomes possible between adjacent passages. This prior art is also described in DE 103 43 107 and U.S. Pat. No. 7,219,719.

The wavy structures within the passages perform three tasks. On the one hand, heat exchange between two media in adjacent passages is ensured by the thermal contact between the wavy structure and the separating sheet. On the other hand, the wavy structures make the connection with the separating sheet. Thirdly, the flanks of the wavy structure serve for introducing the forces arising due to the internal pressure into the connection between the wave crest, solder and separating sheet. According to the prior art, the solder (a) is applied on both sides to the separating sheets, (b) is applied to the wave crests, (c) or is introduced, before the soldering operation, between the wavy structure and separating sheet, with the result that direct contact between the separating sheet and wave crest is made. The thus resulting stack of passages with wavy structures and separating sheets can subsequently, according to the prior art, be introduced as an entire stack into a soldering furnace for the purpose of brazing the stack together.

According to the prior art, the wavy structures are produced from thin sheets which are folded into wavy structures by means of a press or other tools suitable for forming. Owing to the boundary conditions to be adhered to during the forming process, such as radii at the transition between wave crest and flank, and the tolerances arising during the forming process with regard to the ideal form to be achieved, the mechanical strength of a heat exchanger is limited, thus presenting problems when it is used with media under high pressures or high temperatures or a combination of both.

In order to further improve the mechanical strength of a plate heat exchanger of this type, DE 103 43 107 proposes to manufacture the wavy structures from a thick plate which either is hot-extruded or is produced by means of cutting methods. In this case, further parameters relating to the ratio between the thickness of the wavy structure itself and its division, that is to say wavelength and wave amplitude, are proposed.

Thus, an aspect of the present invention is to configure a plate heat exchanger of the type mentioned above in such a way that the strength of the plate heat exchanger under high pressure is increased, as well as a method for producing such a plate heat exchanger.

This can be achieved by configuring a plate heat exchanger with at least one passage having a multiplicity of profiles positioned therein.

In the context of this application, spatial terms, such as top, bottom or lateral, relate to a view of the passage in the plane in which the media participating in the heat exchange flow.

Contrary to the prior art, the wavy structures within the passages are not formed by formed sheets, but, instead, by profiles. In the prior art, an attempt is made to produce an essentially wavy structure which has right-angled flanks, in order to provide a sufficiently large contact surface between the solder and separating sheet and to achieve as perpendicular an introduction of force to the separating sheet as possible. However, this is difficult to achieve in manufacturing terms. In wavy structures which are produced from bent sheets, usually two edges do not stand perpendicularly to one another, but have radii and oblique flanks in the connection. Although this can be avoided by means of the cutting method proposed in DE 103 43 107, the rectangular form is usually lost here due to the brazing operation. As a result of the radii on the wavy structure, a fillet (a weld of generally triangular cross section) is formed between the wave crest of the wavy structure and the separating sheet. The solder usually has a markedly more inhomogeneous structure, as compared with the basic material of the wavy structure and of the separating sheet. Accumulations of brittle microstructure in the fillet hollows will lead, when the plate heat exchanger is operating under high mechanical stresses, to damage to the brazing due to incipient cracks in the fillet. As a result, both the basic material of the wavy structure is weakened and, further, the connection with the separating sheet is damaged.

In the heat exchanger according to the invention, this disadvantage is avoided. According to the invention, the wavy structure is replaced by individual profiles which are arranged next to one another. The profiles are a plurality of inserts positioned within the passage(s) that define the ducts or flow channels within the passage(s) through which the heat exchange media flow. By using profiles according to the invention, the contact surface between the separating sheet and the passage structure is markedly enlarged. In addition, profiles having very good angularities and strengths are available on the market, so that, even after the brazing operation, the contact surface has essentially the same form as before the brazing operation. The formation of a fillet, which can easily crack under high pressure load, is reduced to a minimum by virtue of the present invention. Moreover, the introduction of force is thereby more beneficial, since the webs in these profiles stand virtually perpendicularly and therefore make it difficult for the two contact surfaces to be scraped off by one another.

According to a preferred embodiment of the invention, at least one passage, but preferably all passages contain hollow profiles arranged next to one another within the passage to form the ducts or flow channels. Preferably, the hollow profiles connected to one another have a square or rectangular cross section. The use of hollow profiles with a square or rectangular cross section results in flat or plane surfaces which are highly suitable for wetting with solder and therefore for contacting the hollow profiles with the adjacent separating sheets. The hollow profiles used may in this case be in one part, that is to say consisting of one piece, or be multi-part, that is to say composed of profile parts welded to one another. In this embodiment of the invention, by using square or rectangular hollow profiles, the contact surface between the separating sheets and the passage profile is doubled, as compared with the prior art, if the structure is similar. In the prior art using a wavy structure to form the ducts/flow channels, for each duct only one edge (e.g., the wave crest) has contact with the top or bottom separating sheet. Conversely, in this embodiment of the invention in each case the two mutually opposite sides of the rectangular or square profiles have contact with the separating sheet. The stability of the heat exchanger is thereby appreciably increased.

Advantageously, the hollow profiles are arranged in such a way that no interspace occurs between them, that is to say two adjacent hollow profiles abut against one another at their lateral edges. In this embodiment of the invention, the media participating in heat exchange flow within the hollow profiles. The pressure load is therefore also absorbed essentially by the hollow profiles. That is to say, in this embodiment of the invention, the pressure does not act primarily upon the connection between the wavy structure and separating sheet, as in the prior art, but, instead, is distributed substantially more uniformly by the hollow profiles themselves and is introduced into the structure. The connections between the hollow profile and separating sheets are thus exposed to markedly lower stresses, with the result that the risk that the connection between the hollow profile and separating sheets will be scraped off is also markedly minimized.

According to this embodiment of the invention, the mechanical strength of the plate heat exchanger is thereby markedly increased, as compared with the prior art. Further, the risk of an impairment in the heat transition due to an impairment of the connections between the hollow profiles and separating sheets is minimized.

In another embodiment of the invention, at least one passage, but preferably all passages contain double-T profiles arranged next to one another within the passage to form the ducts or flow channels. In this embodiment of the invention, too, the contact surface between the passage profile and the separating sheet is markedly greater than in the prior art. The double-T profiles are in this case arranged in the passage or passages in such a way that the two bars of the double-T butt onto the separating sheets, and the web between the bars stands perpendicularly to the separating sheet. Contact between the separating sheet and profile takes place via the two bars of the double-T. In this embodiment of the invention too, the profiles are preferably arranged in such a way that no interspace occurs between them, that is to say the two bars of the double-T butt onto the two bars of the adjacent double-T. In this embodiment of the invention, too, the pressure is therefore absorbed essentially by the profile itself and does not act upon the connections between the profile and separating sheets.

Thus, depending on the magnitude of the mechanical stress upon the plate heat exchanger, both the hollow profiles and the double-T profiles may be arranged in abutment or spaced apart from one another.

The widths of the hollow profiles and the double-T profiles are, for example, 0.2-0.6 mm.

According to a further embodiment of the invention, the profiles have perforations on sides not connected to the separating sheets. The lateral perforations, that is to say orifices in the profiles in the passage plane in which the media participating in heat exchange flow, allow a cross mixing of the medium flowing within the ducts/flow channels in the passage. The heat transition is thereby further improved.

According to another embodiment, the hollow profiles of a passage are laterally closed completely or partially.

Advantageously, the profiles and the separating sheets are made from aluminium, steel, high-grade steel, high-temperature steel and/or a nickel-based alloy. In this case, the different materials may also be combined, for example the profiles may be produced from steel and the separating sheets from high-temperature steel.

The plate heat exchanger according to the invention is especially advantageously a plate heat exchanger such as is used in various process segments in air separation plants, petrochemical plants, hydrogen plants or natural-gas plants. In natural-gas plants, in this case, for example, heat is extracted from the natural gas via the heat exchanger. The natural gas is thereby liquefied and separated from the secondary products. In synthesis-gas plants, too, such a plate heat exchanger may be used, inter alia, for the separation and further utilization of substances (H₂, CO, CO₂, CH₄) or for preheating the batch materials. In ethylene plants, heat exchangers of this type are used for the separation of ethylene, and in air separation plants plate heat exchangers are employed in the condenser and evaporator. In general, the desired substance streams can be heated or cooled efficiently with the aid of the plate heat exchanger according to the invention.

In accordance with a method aspect, the invention provides a method for producing a plate heat exchanger comprising:
a) arranging a multiplicity of profiles next to one another,
b) arranging the profiles on a separating sheet, along with providing solder between the profiles and the separating sheet,
c) arranging a further separating sheet on the multiplicity of profiles, along with providing solder between the profiles and the further separating sheet,
d) repeating steps a) to c), so as to form a stack of layers of profiles arranged next to one another, the individual layers of the profiles being arranged on top of one another separated by separating sheets, and
e) brazing the entire stack in a soldering furnace.

Thus, according to a method aspect of the invention, a plurality of profiles are arranged next to one another, are contacted with solder and are placed onto a separating sheet. The next separating sheet is then laid, along with contacting with solder, onto the profiles that have been arranged next to one another. The next layer of profiles arranged next to one another can then be applied to this separating sheet, along with contacting with a solder. Proceeding in this way, a stack of a plurality of passages, separated by separating sheets, is obtained. In this manner, each of the passages is formed with a multiplicity of profiles arranged next to one another which define a plurality of ducts or flow channels in the passage. The entire stack can then be brazed together by being introduced into a soldering furnace. The profiles may in this case be arranged next to one another in abutment, that is to say without an interspace between adjacent profiles, or with an interspace. If the profiles are arranged next to one another with an interspace, their connection to one another takes place via the common connection with the separating sheet. The solder may be applied to either or both the profiles and the separating sheet. The solder is preferably applied to at least the separating sheet.

The passages are delimited laterally by marginal strips, known as sidebars. Within the scope of this invention, a marginal strip is understood to mean any profile consisting of solid material, which has the same height as the profiles which form the ducts or flow channels with the passage.

Advantageously, the profiles are arranged in abutment next to one another. In this embodiment of the invention, the hollow profiles are advantageously tacked to one another, preferably by means of spot welds. As a result, in this embodiment of the invention, the stacking of the individual passages is simplified. However, the profiles do not necessarily have to be connected to one another, since they are also connected via the separating sheet after the brazing of the stack.

The present invention makes it possible, in particular, to provide a plate heat exchanger which is suitable for heat exchange between media under high mechanical stresses. The mechanical stability of the plate heat exchanger according to the invention is markedly improved, as compared with the prior art.

### BRIEF DESCRIPTION OF THE DRAWINGS

The invention and further details, such as features and attendant advantages, of the invention are explained in more detail below on the basis of the exemplary embodiments which are diagrammatically depicted in the drawings, and wherein:

FIG. 1 shows a passage of a plate heat exchanger according to the prior art,

FIG. 2 shows a passage of an embodiment of a plate heat exchanger according to the invention with a hollow profile, and

FIG. 3 shows a passage of an embodiment of a plate heat exchanger according to the invention with a double-T profile.

### DETAILED DESCRIPTION OF THE DRAWINGS

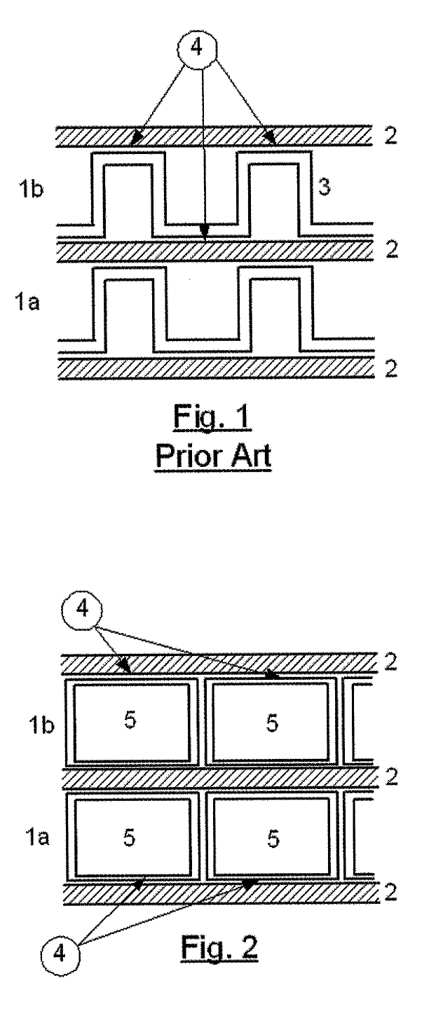

FIG. 1 shows the passages 1a and 1b of a plate heat exchanger according to the prior art. Within the passage 1 is located a wavy structure 3 which has been produced from abent-round sheet. The adjacent passages 1a and 1b are separated from one another by the separating sheet 2. Solder is applied at the contact points 4 between the wavy structure 3 and separating sheet 2. The entire heat exchanger is connected together as a result of the brazing of these soldering points. When two media are routed under pressure into the passages 1a and 1b for heat exchange, the entire passage 1a, 1b is under pressure. The pressure in this case acts, above all, upon the connection points 4 between the wavy structure 3 and separating sheet 2.

FIG. 2 shows the passages 1a and 1b of an embodiment of the plate heat exchanger according to the invention. The passages 1a and 1b have a multiplicity of hollow profiles 5 which are connected to one another and which have a rectangular cross section. The hollow profiles are connected here to the separating sheets 2 via solder in each case at the contact points 4. In this embodiment of the invention, on the one hand, the contact surface and therefore the connection surface between the separating sheet 2 and the structure of the passages 1a and 1b is markedly increased, as compared with the prior art. On the other hand, in contrast to the prior art, essentially only the hollow profiles 5 are under pressure. During heat exchange between two media in the adjacent passages 1a and 1b, therefore, also only the profiles 5 are under the high pressure of the media. The connection points 4 between the hollow profiles 5 and the separating sheets 2 are not exposed to any pressure.

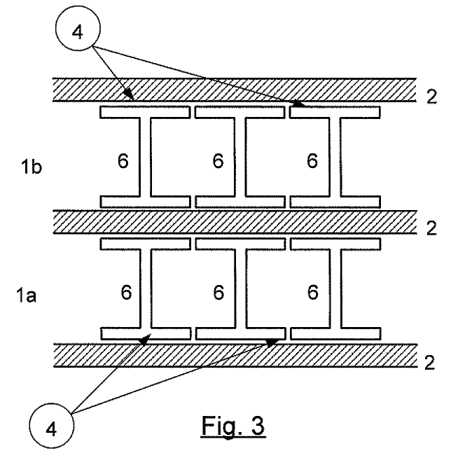

FIG. 3 shows the passages 1a and 1b in a further embodiment of the plate heat exchanger according to the invention. The passages 1a and 1b have a multiplicity of double-T profiles 6 connected to one another. The double-T profiles are in this case connected to the separating sheets 2 via solder at the contact points 4. In this embodiment of the invention, on the one hand, the contact surface and therefore the connection surface between the separating sheet 2 and the structure of the passages 1a and 1b is markedly increased, as compared with the prior art. On the other hand, in contrast to the prior art, essentially only the spaces between the double-T profiles 6 are under pressure. During heat exchange between two media in the adjacent passages 1a and 1b, therefore, also only the double-T profiles 6 are under the high pressure of the media. The connection points 4 between the double-T profiles 6 and the separating sheets 2 are not exposed to any pressure.

The entire disclosure[s] of all applications, patents and publications, cited herein and of corresponding German Application No. 10 2009 018247.0, filed Apr. 21, 2009 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A plate heat exchanger for heat exchange between at least two media, comprising:
a multiplicity of passages (1a, 1b) arranged in stack form and separated from one another by separating sheets (2), wherein the passages (1a, 1b) are structured (3, 5) to provide a plurality of flow channels, and
wherein at least one passage (1a, 1b) is provides with a multiplicity of profiles (5, 6) that define said plurality of flow channels.

2. A plate heat exchanger according to claim 1, wherein said at least one passage (1a, 1b) is formed with a plurality of hollow profiles (5) arranged next to one another.

3. A plate heat exchanger according to claim 2, wherein all of said passages (1a, 1b) are formed with a plurality of hollow profiles (5) arranged next to one another.

4. A plate heat exchanger according to claim 2, wherein said hollow profiles (5) arranged next to one another have a square or rectangular cross section.

5. A plate heat exchanger according to claim 3, wherein said hollow profiles (5) arranged next to one another have a square or rectangular cross section.

6. A plate heat exchanger according to claim 1, wherein said at least one passage (1a, 1b) is formed with a plurality of double-T profiles (6) arranged next to one another.

7. A plate heat exchanger according to claim 1, wherein all of said passages (1a, 1b) are formed with a plurality of double-T profiles (6) arranged next to one another.

8. A plate heat exchanger according to claim 1, wherein said profiles (5, 6) have perforations on sides not connected to said separating sheets.

9. A plate heat exchanger according claim 1, wherein said separating sheets (2) and profiles (5, 6) are made from aluminium, steel, high-grade steel, high-temperature steel, and/or a nickel-based alloy.

10. A method for producing a plate heat exchanger comprising:
a) arranging a multiplicity of profiles next to one another,
b) arranging said profiles on a separating sheet, along with providing solder between the profiles and said separating sheet,
c) arranging a further separating sheet on the multiplicity of profiles, along with providing solder between the profiles and said further separating sheet,
d) repeating steps a) to c), so as to form a stack of layers of profiles arranged next to one another, the individual layers of the profiles being arranged on top of one another separated by the separating sheets, and
e) brazing the entire stack in a soldering furnace.

11. A method according to claim 10, wherein said profiles (5, 6) are arranged in abutment next to one another.

12. A method according to claim 11, wherein said profiles (5, 6) are connected to one another in abutment.

13. A method according to claim 12, wherein said profiles (5, 6) are connected by means of spot welds.
